(19) United States
(12) Patent Application Publication
(10) Pub. No.: US 2025/0371253 A1
(43) Pub. Date: Dec. 4, 2025

(54) ATTRIBUTION OF DECOMPOSED PARAGRAPHS TO SUPPORTING DOCUMENTS

(71) Applicant: Adobe Inc., San Jose, CA (US)

(72) Inventors: Abhilasha Sancheti, Bhilwara (IN); Koustava Goswami, Bengaluru (IN); Balaji Vasan Srinivasan, Bangalore (IN)

(73) Assignee: Adobe Inc., San Jose, CA (US)

(21) Appl. No.: 18/680,983

(22) Filed: May 31, 2024

(51) Int. Cl. G06F 40/169; G06F 40/289

(52) U.S. Cl. CPC G06F 40/169; G06F 40/289

(57) ABSTRACT

In accordance with the described techniques, a processing device receives one or more documents and one or more paragraphs formulated from content of the one or more documents. Using a text decomposition model, the processing device decomposes the one or more paragraphs into a plurality of statements. Using a natural language inference model, the processing device attributes a statement of the plurality of statements to one or more sentences of the one or more documents. Further, the processing device generates one or more annotated documents including at least one visual indication associating the statement with the one or more sentences.

### BACKGROUND

Generative artificial intelligence (AI) improves efficiency for many content generation tasks. For example, generative text models often generate answers to questions or prompts by taking information from a variety of sources, summarizing and synthesizing the information, and providing an answer to the user in natural language. Thus, given an appropriate prompt, the generative text model is able to automatically generate textual content, such as emails, articles and blog posts, product descriptions, reports and summaries, social media posts, customer support responses, and so on.

### SUMMARY

An answer attribution system includes a generative text model, a text decomposition model, and a natural language inference model. The answer attribution system receives a prompt and one or more documents, and the generative text model generates an answer (e.g., including one or more paragraphs) based on the prompt that requests formulation of the answer relying solely on the content of the document. Further, the text decomposition model decomposes the answer into a plurality of statements representing different facts, opinions, and propositions expressed in the answer, such that at least one sentence of the answer is decomposed into multiple statements.

The answer attribution system employs the natural language inference model to attribute the plurality of statements to corresponding sentences of the one or more documents. To do so for a respective statement, the natural language inference model generates attribution scores measuring a degree to which the respective statement is inferable by individual sentences in the one or more documents. A particular sentence having a first attribution score is added to a list of supporting sentences that support the respective statement based on the attribution scores. Next, a sentence selection algorithm is employed to greedily add remaining sentences of the document to the supporting sentences that, when combined with the particular sentence, increase the attribution score with respect to the respective statement. Furthermore, the answer attribution system generates one or more annotated documents including visual indications associating the plurality of statements with the corresponding sentences.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ techniques described herein for attribution of decomposed paragraphs to supporting documents.

FIG. 2 depicts a system in an example implementation showing operation of an answer attribution system to generate an annotated document including attributions of decomposed statements to corresponding sentences of one or more documents.

FIG. 3 depicts a system in an example implementation showing operation of an answer attribution system to decompose one or more paragraphs of an answer into a plurality of statements.

FIG. 4 depicts a system in an example implementation showing operation of an answer attribution system to attribute a decomposed statement to one or more sentences of one or more documents.

FIG. 5 depicts a system in an example implementation showing operation of an answer attribution system to identify a statement as hallucinated by a generative text model.

FIGS. 6A, 6B, and 6C depict an example user interface for interacting with an annotated document generated by an answer attribution system.

FIG. 7 is a flow diagram depicting a procedure in an example implementation for attribution of decomposed paragraphs to supporting documents.

FIG. 8 is a flow diagram depicting a procedure in an example implementation for attribution of decomposed paragraphs to supporting documents.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

### Overview

Generative artificial intelligence (AI) models are machine learning models that generate content (e.g., textual content, image content, video content, and/or audio content) based on a prompt. By way of example, a generative text model receives a prompt as input, and generates a natural language answer to the prompt that synthesizes and summarizes information from one or more information sources. For certain text generation tasks, however, it is important for a user to know which sources were relied on by the generative text model in generating the answer to verify that the answer is accurate and comes from reliable information sources. Accordingly, answer attribution techniques are often employed in conjunction with text generation using generative AI, which identify and present information sources to the user that provide support for the generated content.

Conventional answer attribution techniques, however, often attribute an answer in its entirety to an information source. This is problematic for long form, abstractive answers, in which a generated answer includes one or more paragraphs having a plurality of sentences, and each of the sentences potentially contain multiple independently verifiable facts, opinions, and/or propositions. In order to properly verify that a long form, abstractive answer is supported by the information source, therefore, a user of a conventionally configured system manually matches finer granularity portions of the text (e.g., sentences) in the answer to portions of the information source, which is a time consuming and tedious process. Moreover, conventional answer attribution techniques fail to efficiently attribute the answer (or portions thereof) to multiple distinct portions of an information source. This is problematic in situations in which answers are attributed to content in the information source at a particular granularity (e.g., at paragraph-level granularity), and portions of the answer come from different paragraphs.

To overcome the limitations of conventional techniques, techniques for attribution of decomposed paragraphs to supporting documents are described herein as implemented by an answer attribution system. In accordance with the described techniques, a generative text model receives a prompt and a document having a plurality of sentences. The generative text model, for example, is a large language model (LLM) (e.g., a generative pre-trained transformer model) pre-trained to perform a variety of natural language processing tasks, including question/prompt answering. As output, the generative text model generates an answer based on the prompt that requests the generative text model to rely solely on content of the document in formulating the answer. By way of example, the document is a business report, the prompt is “summarize the findings in the business report using only support found in the provided documents,” and the answer includes the sentence “the customer base grew 27% year-over-year to 173 million customers, or 170 million customers excluding a one-time benefit of 3 million users.” In various examples, the answer is a long form answer (e.g., a multi-sentence paragraph or a multi-paragraph passage) and is abstractive, e.g., sentences of the answer summarize and synthesize information from multiple portions of the document in natural language.

The answer is provided as input to a text decomposition model along with a prompt requesting the text decomposition model to decompose the answer into a plurality of statements. In one or more implementations, the text decomposition model is an LLM (e.g., a generative pre-trained transformer model) pre-trained to perform a variety of natural language processing tasks, including identifying linguistic elements in a passage. Thus, as output, the text decomposition model generates a decomposed answer, including a plurality of statements representing different facts, opinions, and propositions expressed in the answer. In one or more implementations, the text decomposition model decomposes at least one sentence of the answer into multiple statements. Continuing with the previous example, the decomposed answer includes the following statements: (1) the customer base grew 27% year-over-year, (2) the customer base grew to 173 million, (3) the customer base grew to 170 million excluding a one-time benefit, and (4) the one-time benefit was 3 million customers.

In accordance with the described techniques, a natural language inference model receives the plurality of sentences of the document and a particular statement of the decomposed answer. The natural language inference model is an LLM that is pre-trained to perform a variety of natural language processing tasks, and has been refined and/or fine-tuned for the task of natural language inference on one or more natural language inference datasets. By way of example, the natural language inference datasets include training samples each having a premise, a hypothesis, and a label indicating whether the hypothesis is inferable by the premise. Further, the natural language inference model is fine-tuned to determine whether a given hypothesis is inferable by a given premise on the natural language inference datasets. Here, the particular statement is the hypothesis, and the sentences correspond to the premises.

In particular, the natural language inference model generates an attribution score for each sentence of the document with respect to the particular statement. The attribution scores measure a degree to which the particular statement is inferable by individual sentences of the document. Further, a particular sentence having a highest attribution score is selected, and added to a list of one or more supporting sentences that provide evidentiary support and/or additional details regarding the particular statement. Next, a sentence selection algorithm is employed to greedily add remaining sentences of the document to the supporting sentences that, when combined with the particular sentence, increase the attribution score with respect to the particular statement.

As part of this, the natural language inference model is employed to generate a combined attribution score which measures a degree to which the particular statement is inferable by a combination of a remaining sentence and the one or more supporting sentences. Next, the sentence selection algorithm determines whether the combined attribution score exceeds a current attribution score by at least a predetermined delta value. Notably, the current attribution score is measured between the particular statement and the current combination of one or more supporting sentences. If the combined attribution score exceeds the current attribution score by the predetermined delta value, then the remaining sentence is added to the list of supporting sentences that support the particular statement. Otherwise, the remaining sentence is not added to the list of supporting sentences.

This process is repeated to evaluate each remaining sentence of the document for addition to the supporting sentences that support the particular statement. In addition, this process is repeated to attribute each statement of the decomposed answer to corresponding sentences in the document.

In one or more implementations, the answer attribution system compares the attribution scores measured between a respective statement and the individual sentences of the document to an attribution threshold. If at least one attribution score equals or exceeds the threshold, then a sentence having a highest attribution score is added to the supporting sentences, and the remaining sentences are evaluated for addition to the supporting sentences, as discussed above. If, however, each of the attribution scores fall below the attribution threshold, then the respective statement is determined as not attributable to the answer.

Based on the attribution scores for the respective statement falling below the attribution threshold, the respective statement is provided to a language classification model, which is a machine learning model having been trained to classify statements as assertive language or non-assertive language. Notably, assertive language corresponds to assertions in the form of facts, opinions, and propositions. In contrast, non-assertive language corresponds to language that is not assertions of fact, opinion, or proposition. Examples of non-assertive language include questions, filler language (e.g., superfluous or redundant language), suggestions, and so on. Furthermore, the answer attribution system determines that the respective statement is hallucinated by the generative text model based on the attribution scores between the statement and the individual sentences falling below the attribution threshold, and the respective statement being classified as assertive language.

After each of the statements are attributed (or evaluated but not attributed) to the corresponding sentences of the document, the answer attribution system generates an annotated document, e.g., for display in a user interface. To do so, the answer attribution system incorporates the decomposed answer into the document, and marks the statements of the decomposed answer with visual indications. Further, the answer attribution system marks the sentences with corresponding visual indications of the statements with which the sentences are matched. Continuing with the previous example, the statements are numbered (1)-(4), statement (1) is attributed to a particular sentence of the document, and the particular sentence of the document has the number (1) appended to the end of the sentence in the annotated document. Additionally or alternatively, the hallucinated statement is visually distinguished from the statements that are attributable to at least one sentence of the document.

In one or more implementations, the answer attribution system receives user feedback updating the generated attributions, e.g., as generated automatically by the answer attribution system. For example, the user feedback attributes one or more statements to different or additional sentences in the document. Given this, the answer attribution system further trains the natural language inference model based on a degree of difference between the generated attributions and the updated attributions. In this way, the answer attribution system uses continuous learning to train the natural language inference model to attribute the statements to appropriate sentences in the document, while adapting to changing attribution preferences of a user population.

Thus, in contrast with conventional techniques, the described techniques decompose an answer into a plurality of statements, and in various examples decompose a singular sentence of the answer into multiple statements. Further, the described techniques attribute the statements to corresponding sentences of the document. In other words, the described techniques attribute textual content in the answer to portions of the document at a finer granularity than conventional techniques, e.g., at statement-level granularity rather than answer-level granularity. By doing so, a user is able to more efficiently verify that long form, abstractive answers are supported by the document. Moreover, the described techniques increase computational efficiency for the task of attributing a statement to multiple sentences of the document. This is because the sentence selection algorithm evaluates, for a respective statement, each remaining sentence of the document for addition to the supporting sentences just once, rather than generating attribution scores for all possible combinations of sentences.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Paragraph Decomposition and Attribution Environment

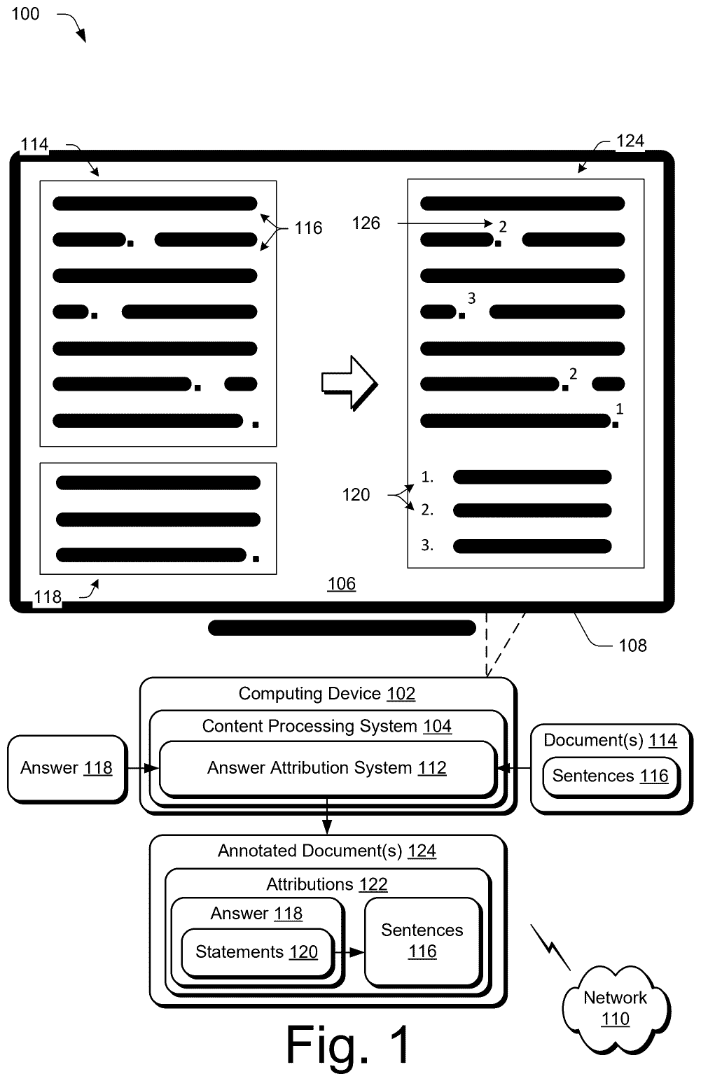

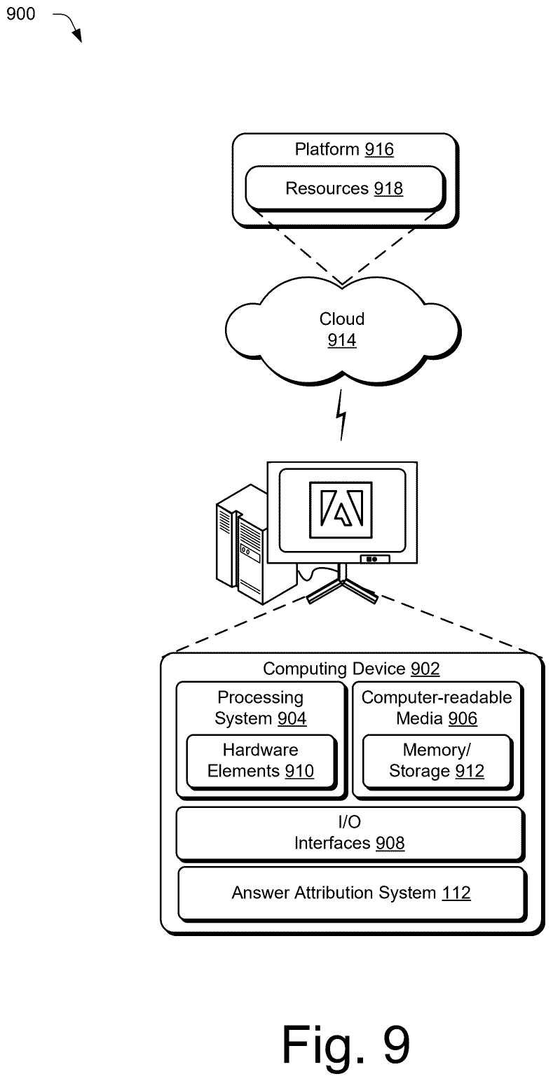

FIG. 1 is an illustration of an environment 100 in an example implementation that is operable to employ techniques described herein for attribution of decomposed paragraphs to supporting documents. The illustrated environment 100 includes a computing device 102, which is configurable in a variety of ways. The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 9.

The computing device 102 is illustrated as including a content processing system 104. The content processing system 104 is implemented at least partially in hardware of the computing device 102 to process and transform digital content. Such processing includes creation of the digital content, modification of the digital content, and rendering of the digital content in a user interface 106 for output, e.g., by a display device 108. Although illustrated as implemented locally at the computing device 102, functionality of the content processing system 104 is also configurable as whole or part via functionality available via the network 110, such as part of a web service or “in the cloud.”

An example of functionality incorporated by the content processing system 104 to process the digital content is illustrated as an answer attribution system 112. As shown, the answer attribution system 112 receives, as input, one or more documents 114 having a plurality of sentences 116, and an answer 118 formulated from content of the one or more documents 114. By way of example, a generative text model generates an answer 118 to a prompt, and the answer 118 includes one or more paragraphs. In accordance with the described techniques, the answer attribution system employs a text decomposition model to decompose the answer 118 into a plurality of statements 120. In one or more implementations, the statements 120 are representative of different facts, opinions, and propositions expressed in the answer 118. Oftentimes, a singular sentence in the answer 118 includes multiple independent facts, opinions, and/or propositions, and as such, the text decomposition model decomposes the singular sentence into multiple statements 120, as shown in the illustrated example.

In one or more implementations, the answer attribution system 112 employs a natural language inference model to generate attributions 122 attributing the statements 120 to corresponding sentences 116 of the one or more documents 114. Generally, “attributing” a statement 120 to a sentence 116 means that the sentence 116 provides evidentiary support for and/or additional details regarding the statement 120. As part of this, the natural language inference model generates attribution scores for a statement 120 measuring a degree to which the statement 120 is inferable by individual sentences 116 of the document 114. Moreover, the answer attribution system 112 attributes the statement 120 to a first sentence 116 having a highest attribution score, and employs a greedy sentence selection algorithm that attributes the statement 120 to additional sentences 116, which in combination with the initial sentence 116, increase the attribution score for the statement 120. This process is repeated for each statement 120 of the answer 118, resulting in one or more statements 120 that are attributed to multiple sentences 116. As shown in the illustrated example, the answer attribution system 112 generates one or more annotated documents 124 that include visual indications 126 of the attributions 122.

Conventional answer attribution techniques often attribute an answer in its entirety to a document (or portions thereof), and fail to efficiently attribute an answer to multiple portions (e.g., sentences, paragraphs, or passages) of a document. By decomposing the answer 118 into a plurality of statements 120 and attributing the statements 120, the described techniques enable a user to more efficiently verify that long form, abstractive answers 118 are supported by the provided document 114. Moreover, the described techniques enable attribution of a statement 120 to combinations of sentences 116 with increased computational efficiency. This is because the greedy sentence selection algorithm evaluates, as supporting a respective statement 120, a reduced subset of sentence combinations in the document 114.

### Paragraph Decomposition and Attribution Features

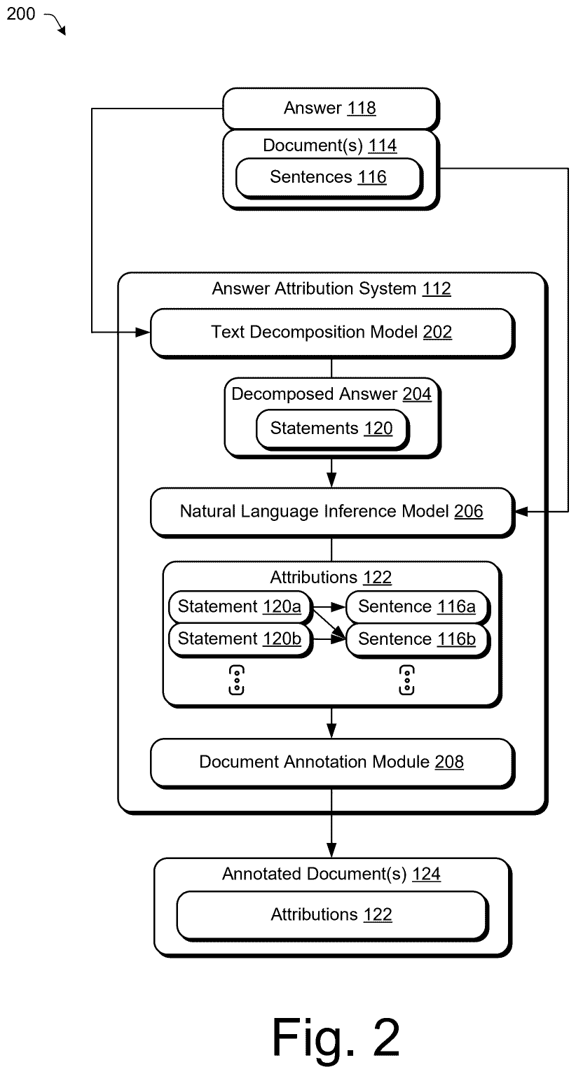

FIG. 2 depicts a system 200 in an example implementation showing operation of an answer attribution system to generate an annotated document including attributions of decomposed statements to corresponding sentences of one or more documents. As shown, the answer attribution system 112 receives one or more documents 114 having a plurality of sentences 116, and an answer 118 formulated from content of the document 114. Although techniques are described herein in which the answer attribution system 112 attributes portions of the answer 118 to sentences 116 in the document 114, it is to be appreciated that the described techniques are applicable to attributing portions of the answer 118 to different granularities of textual content in the document 114, e.g., portions of sentences, paragraphs, passages, and/or pages.

In one or more implementations, the answer 118 is a long form, abstractive answer. For instance, in contrast to a short form answer (e.g., one word or one phrase), the answer 118 is a multi-sentence paragraph or a multi-paragraph passage. Further, in contrast to an extractive answer (e.g., a word or phrase extracted directly from the document 114), a sentence of the answer 118 summarizes and synthesizes information from multiple portions of the document 114 in natural language. Moreover, the answer attribution system 112 employs a post-hoc attribution technique in which the answer 118 is generated first, and thereafter, the answer 118 is decomposed and attributed to the sentences 116 of the document 114. Given this, the described techniques are applicable to answers 118 generated manually by a human or automatically by a question answering system, e.g., ChatGPT.

In particular, the answer 118 is provided, as input, to a text decomposition model 202, which is a machine learning model that has been trained to decompose an answer 118 into statements 120 representing different facts, opinions, and propositions expressed in the textual content. As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data.

According to various implementations, such a machine learning model uses supervised learning, semi-supervised learning, unsupervised learning, reinforcement learning, continuous learning, interactive learning, and/or transfer learning. For example, a machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

As shown, the text decomposition model 202 receives the answer 118, as input, and outputs a decomposed answer 204 that includes the statements 120 representing different facts, opinions, and propositions expressed in the answer 118. The decomposed answer 204 is provided to a natural language inference model 206, which is a machine learning model that has been trained to receive a premise and a hypothesis, and output an attribution score measuring a degree to which the hypothesis is inferable by the premise. Here, the statements 120 correspond to the hypotheses, while the sentences 116 in the document 114 correspond to the premises.

Using the natural language inference model 206, the answer attribution system 112 generates attributions 122 of the statements 120 to corresponding sentences 116 of the document 114. Given a particular statement 120, for instance, the natural language inference model 206 generates attribution scores measuring a degree to which the particular statement 120 is inferable by respective sentences 116 of the document 114. Furthermore, the answer attribution system 112 attributes the particular statement 120 to a first sentence 116 having a highest attribution score. In addition, the answer attribution system 112 selectively attributes the particular statement 120 to additional sentences 116 of the document 114, which when considered together with the first sentence 116, increase the attribution score for the particular statement 120. As a result, the answer attribution system 112 attributes at least one statement 120 to multiple sentences 116. For example, the statement 120a is attributable to multiple sentences 116a, 116b, while the statement 120b is attributable to just one sentence 116b.

As shown, the attributions 122 are received by a document annotation module 208, which is representative of functionality for generating one or more annotated documents 124, including visual indications of the attributions 122. By way of example, the document annotation module 208 generates the annotated document 124 by adding the statements 120 to the document 114 and marking each of the statements 120 with a different visual indication. Further, the document annotation module 208 marks respective sentences 116 with the visual indication of the one or more statements 120 to which the respective sentences 116 are matched.

In one example, the annotated document 124 is annotated in a “footnote” format, in which the statements 120 are numbered, and the sentences 116 are marked with numbers assigned to the statements 120 with which the sentences 116 are matched. Additionally or alternatively, the annotated document 124 is annotated in a “color-coded” format in which the statements 120 are highlighted with different colors, and the sentences 116 are highlighted with colors assigned to the statements 120 with which the sentences 116 are matched. It is to be appreciated, however, that any one or more of a variety of visual indications are employable by the document annotation module 208 to visually distinguish the statements 120 and visually indicate correspondence with the sentences 116.

Although techniques are described herein as attributing portions of the answer 118 to textual portions of the one or more documents 114, it is to be appreciated that the described techniques are applicable to attribute portions of the answer 118 to different modalities of content in the document 114, e.g., image content, video content, and audio content. One example of this functionality includes leveraging one or more machine learning models to convert image content, video content, and audio content to textual summaries. In an example of image-to-text conversion, the answer attribution system 112 provides images from the one or more documents 114 to an image captioning model, examples of which include a Show and Tell Model, a Show, Attend, and Tell Model, and a Bottom-Up and Top-Down Attention Model. Further, the image captioning model generates captions for each of the images in the document 114.

In an example of video-to-text conversion, the answer attribution system 112 employs a pre-trained video-to-text model (e.g., VideoBERT) that has been refined for the task of generating textual video summaries. For instance, the pre-trained video-to-text model receives training data in the form of videos paired with ground truth summaries. Using supervised learning, the pre-trained video-to-text model learns to output video summaries for videos that reflect patterns present in the training data. Given this, the video-to-text model generates textual summaries of the videos in the document 114. In an example of audio-to-text conversion, the answer attribution system 112 transcribes audio (e.g., in the form of speech) to text. Further, the answer attribution system 112 prompts a pre-trained large language model, such as ChatGPT, to summarize the transcribed speech to in accordance with a particular size, e.g., 200 words or less.

In accordance with these examples, the image captions, video summaries, and transcribed speech summaries are used as additional premises for the natural language inference model 206 to evaluate. When an image caption, video summary, or transcribed audio summary is identified as a premise that supports a statement 120 of the decomposed answer 204, the one or more annotated documents 124 include visual indications marking the corresponding image, the corresponding video, or the corresponding audio file as associated with the statement 120.

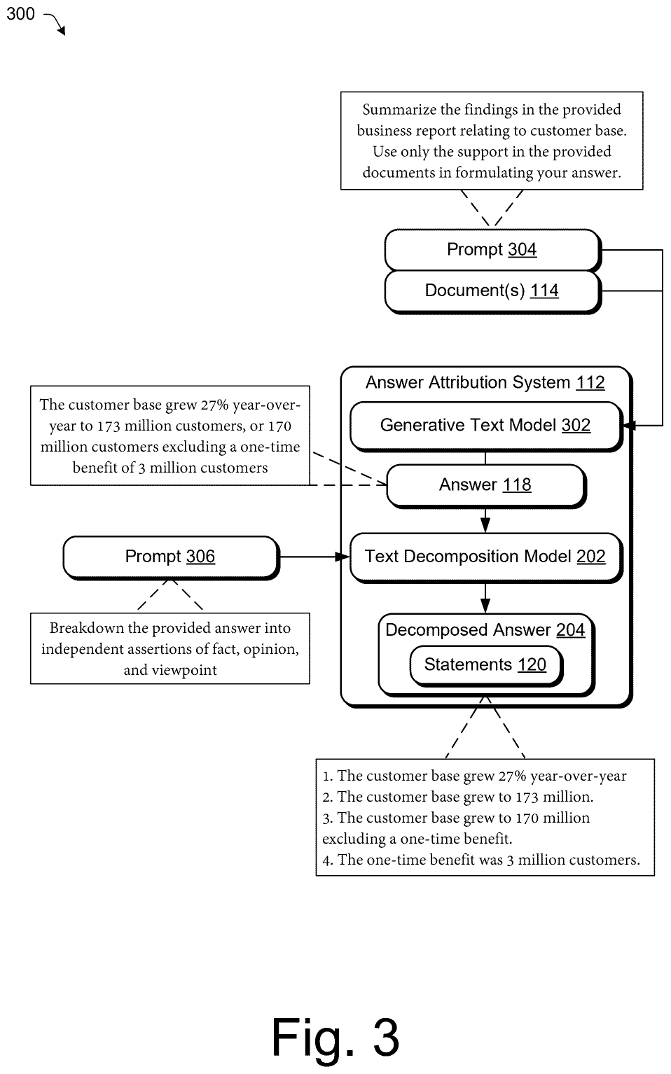

FIG. 3 depicts a system 300 in an example implementation showing operation of an answer attribution system to decompose one or more paragraphs of an answer into a plurality of statements. As shown, the answer attribution system 112 includes a generative text model 302 that receives the document 114 and a prompt 304. The generative text model 302 is a large language model (LLM) that is pre-trained to perform a variety of natural language processing (NLP) tasks. Examples of the machine learning generative text model 302 include, but are not limited to, generative pre-trained transformer (GPT) models, bidirectional encoder representations from transformers (BERT) models, robustly optimized BERT approach models (RoBERTa) models, and text-to-text transfer transformer (T5) models.

Here, the prompt 304 requests the model 302 to rely only on content of the document 114 in formulating an answer 118 to the prompt 304. As output, the model 302 generates a long form, abstractive answer 118. In other words, the generative text model 302 employs an abstractive, source restricted question answering technique in which the answer 118 is given in natural language summarizing and synthesizing information from only the provided document 114. Examples of the content relied on by the generative text model 302 includes plain language text (e.g., paragraphs), document headers, tables, footnotes, figures, images, and lists of the document 114, to name just a few. This question answering technique contrasts with extractive question answering techniques in which portions of the document 114 are extracted verbatim as the answer 118, and source-unrestricted question answering techniques in which answers 118 are generated based on an unrestricted knowledge corpus, e.g., the internet. It is to be appreciated, however, that the described techniques are extendable to source-unrestricted question answering techniques as well.

In accordance with the described techniques, the text decomposition model 202 receives the answer 118 and a prompt 306, and outputs the decomposed answer 204 including the plurality of statements 120. In one or more implementations, the text decomposition model 202 decomposes one or more sentences of the answer 118 into multiple statements 120. By way of example, the answer 118 in the illustrated example is expressed in one sentence, but is decomposed into four independent statements 120 representing different facts expressed in the answer 118. In various examples, the text decomposition model 202 removes “filler” (e.g., superfluous or redundant) language in generating the decomposed answer 204, as well as facts, opinions, and propositions that are repeated in the answer 118.

In one or more implementations, the text decomposition model 202 is an LLM (e.g., a GPT model, a BERT model, a RoBERTa model, or a T5 model) that is pre-trained to perform a variety of NLP tasks. These pre-trained LLM models have demonstrated proficiency in decomposing sentences into independent facts, opinions, and propositions. Given this, the answer attribution system 112 employs these pre-trained LLM models in an “off-the-shelf” manner in one or more implementations, e.g., little to no training data is leveraged to fine-tune the pre-trained LLM models. In accordance with this approach, the text decomposition model 202 receives the prompt 306 requesting the model 202 to decompose the answer into independent assertions of fact, opinion, or proposition. In one or more implementations, the prompt 306 is generated automatically by the answer attribution system 112, e.g., without human involvement crafting or generating the prompt 306.

Additionally or alternatively, the text decomposition model 202 is specifically trained for the task of decomposing an answer 118 into statements 120 representing different facts, opinions, and propositions expressed in the answer 118. In one or more implementations, the answer attribution system 112 leverages supervised learning to train the text decomposition model 202 on a plurality of training pairs each including a training answer and a corresponding label. Here, the label includes ground truth statements expressed in the training answer.

During a training phase, the text decomposition model 202 is employed to decompose the training answer into predicted statements. Furthermore, the answer attribution system 112 trains the text decomposition model 202 by updating parameters of the text decomposition model 202 based on a loss between the predicted statements and the ground truth statements of a training pair. In one or more implementations, the predicted statements and the ground truth statements are first encoded (e.g., as vectors) using a word embedding technique (e.g., Word2Vec) or a sentence embedding technique (e.g., Sentence-BERT) to capture semantic meaning of the statements 120. Given this, the loss corresponds to a cross-entropy loss between the vectors representing the predicted statements and the vectors representing the ground truth statements. This process is repeated iteratively on different training pairs until the loss converges to a minimum, a threshold number of iterations have completed, or a threshold number of epochs have been processes.

In implementations involving the specifically trained text decomposition model 202, the text decomposition model 202 receives the answer 118 (without the prompt 306), and decomposes the answer 118 into the plurality of statements 120. Regardless of whether the pre-trained LLM or the specifically trained model is employed, the text decomposition model 202 produces a decomposed answer 204 in which at least one sentence of the answer 118 is decomposed into multiple statements 120, as shown in the illustrated example.

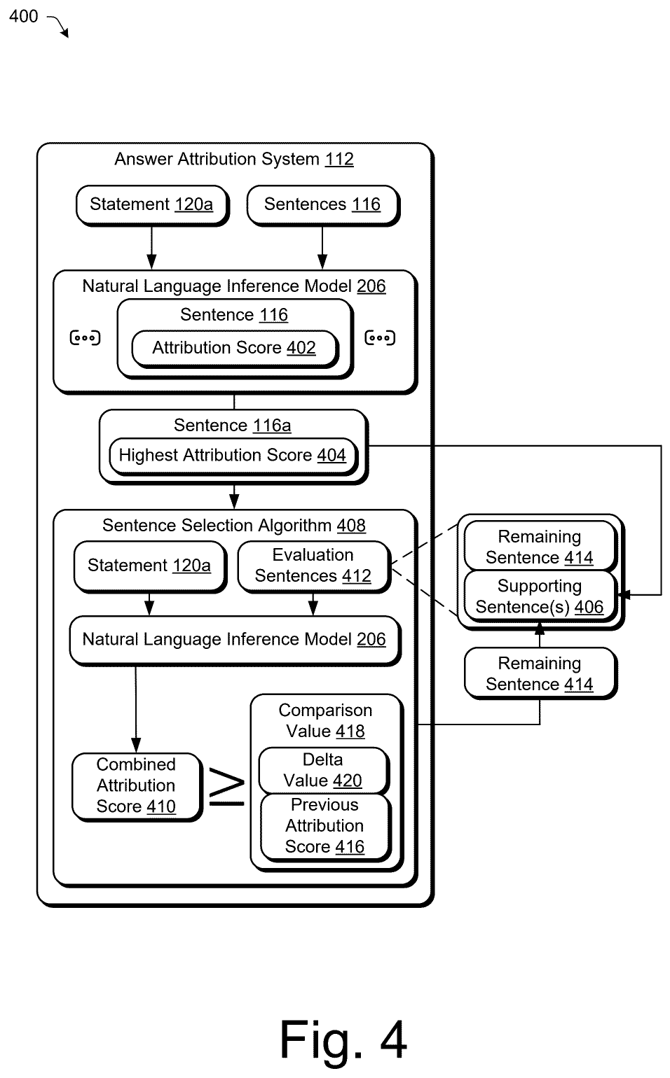

FIG. 4 depicts a system 400 in an example implementation showing operation of an answer attribution system to attribute a decomposed statement to one or more sentences of one or more documents. As shown, the natural language inference model 206 receives a statement 120a and the plurality of sentences 116 of the one or more documents 114, and the natural language inference model 206 generates attribution scores 402 for each individual sentence 116 with respect to the statement 120a. Generally, an attribution score 402 measures a degree to which the statement 120a is inferable by a respective individual sentence 116 in the one or more documents 114. In at least one example, the attribution score 402 is a confidence value measured on a scale from zero to one, with one representing 100% confidence that the statement 120a is inferable by a respective individual sentence 116.

In one or more implementations, the natural language inference model 206 is an LLM (e.g., a GPT model, a BERT model, a RoBERTa model, or a T5 model) that is pre-trained to perform a variety of NLP tasks, and fine-tuned for the task of natural language inference (NLI) on one or more NLI datasets, i.e., also referred to as a textual entailment model. Any one or more of a variety public or proprietary NLI datasets are usable to fine-tune the natural language inference model 206. One example of an NLI dataset on which the natural language inference model 206 is trained is the DocNLI dataset as described in “DocNLI: A Large-Scale Dataset for Document-Level Natural Language Inference” by Wenpeng Yin, Dragomir Radev, and Caiming Xiong, arXiv preprint arXIV 2106.09449 (2021), which is hereby incorporated by reference in its entirety. Additional or alternative examples of the NLI dataset include, but are not limited to, the multi-genre NLI (MNLI) dataset, the Stanford NLI (SNLI) dataset, the Adversarial NLI (ANLI) dataset, the SciTail dataset, the Cross-Lingual NLI (XNLI) dataset, to name just a few.

In at least one implementation, the NLI dataset(s) include a plurality of training samples each including a premise paired with a hypothesis, and a label indicating whether the training sample is a positive training sample (e.g., the hypothesis is inferable by the premise) or a negative training sample, e.g., the hypothesis is not inferable by the premise. In one or more implementations, the premises are long form premises (e.g., at least a paragraph long, including multi-paragraph passages, and entire documents), while the hypotheses are single sentences or multi-sentence paragraphs. In at least one example, the training samples are labeled in a binary manner, e.g., positive training samples are labeled with a one, while negative training samples are labeled with a zero. Using the NLI dataset, the answer attribution system 112 leverages supervised learning to train the natural language inference model 206.

During training, the natural language inference model 206 is employed to generate an attribution score 402 for the training sample, e.g., measuring a degree to which the hypothesis of the training sample is inferable by the premise of the training pair. As previously mentioned, the attribution score 402 is measured on a scale from zero to one. Accordingly, the answer attribution system 112 trains the natural language inference model 206 by updating parameters of the natural language inference model 206 based on a loss between the label (e.g., one or zero) of the training sample and the generated attribution score 402, e.g., ranging from zero to one. This process is repeated on different training samples until the loss converges to a minimum, a threshold number of iterations have completed, or a threshold number of epochs have been processed.

Although the natural language inference model 206 (e.g., the textual entailment model) is described herein as attributing statements 120 to the sentences 116 in the document 114, it is to be appreciated that the statements 120 are attributable to the sentences 116 in other manners without departing from the spirit or scope of the described techniques. Examples include text retrieval (e.g., dense text retrieval, sparse text retrieval, or hybrid text retrieval) techniques and/or models (such as OpenSearch Retrieval) and fuzzy matching algorithms.

As shown, the natural language inference model 206 outputs a sentence 116a having a highest attribution score 404 from among the attribution scores 402. Practically, the sentence 116a is the individual sentence 116 of the document 114 that the statement 120a is most attributable to. Furthermore, the answer attribution system 112 attributes the statement 120a to the sentence 116a by adding the sentence 116a to a list of supporting sentences 406 that provide evidentiary support or additional details regarding the statement 120a.

Moreover, a sentence selection algorithm 408 employs the natural language inference model 206 to generate a combined attribution score 410 measuring a degree to which the statement 120a is inferable by a combination of evaluation sentences 412. As shown, the evaluation sentences 412, include a remaining sentence 414 and the supporting sentences 406. Broadly, the remaining sentences 414 include the sentences 116 of the documents 114 excluding the sentence 116a already added to the list of supporting sentences 406.

Further, the sentence algorithm 408 compares the combined attribution score 410 to a previous attribution score 416. The previous attribution score 416 is the attribution score associated with the supporting sentences 406, e.g., measuring a degree to which the statement 120a is inferable by the current combination of supporting sentences 406. More specifically, the sentence selection algorithm 408 generates a comparison value 418 by adding a predetermined delta value 420 to the previous attribution score 416, and compares the combined attribution score 410 to the comparison value 418.

If the combined attribution score 410 equals or exceeds the comparison value 418, the remaining sentence 414 is added to the list of supporting sentences 406, and the combined attribution score 410 becomes the previous attribution score 416 for a next iteration of the sentence selection algorithm 408 that evaluates a different remaining sentence 414. By utilizing the delta value 420, the sentence selection algorithm 408 avoids extensive lists of supporting sentences 406 for the statement 120a by refraining from adding remaining sentences 414 to the supporting sentences 406 that marginally increase support for the statement 120a.

Given the above, in a first iteration of the sentence selection algorithm 408, the natural language inference model 206 generates a combined attribution score 410 measuring a degree to which the statement 120a is inferable by a combination of the sentence 116a and a first remaining sentence 414. Further, the sentence selection algorithm 408 generates a comparison value 418 by adding the delta value 420 to the previous attribution score 416. Here, since the sentence 116a is the only supporting sentence 406, the previous attribution score 416 is the highest attribution score 404, e.g., the attribution score 402 measured between the statement 120a and the sentence 116a.

If the combined attribution score 410 equals or exceeds the comparison value 418, the sentence selection algorithm 408 adds the first remaining sentence 414 to the supporting sentences 406. Further, the previous attribution score 416 becomes the combined attribution score 410 for the next iteration of the sentence selection algorithm 408 that evaluates a second remaining sentence 414 for addition to the supporting sentences 406. Thus, in the next iteration, the evaluation sentences 412 include the second remaining sentence 414 and the supporting sentences 406 (e.g., the sentence 116a and the first remaining sentence 414), and the previous attribution score 416 is the attribution score measured between the statement 120a and the supporting sentences 406.

If, however, the combined attribution score 410 falls below the comparison value 418, the sentence selection algorithm does not add the first remaining sentence 414 to the supporting sentences 406. Further, the previous attribution score 416 remains as the highest attribution score 404 for the next iteration of the sentence selection algorithm 408 that evaluates a second remaining sentence 414 for addition to the supporting sentences 406. Thus, in the next iteration, the evaluation sentences 412 include the second remaining sentence 414 and the supporting sentence 406 (e.g., the sentence 116a), and the previous attribution score 416 is the highest attribution score 404 measured between the statement 120a and the sentence 116a.

This process is repeated to evaluate whether each of the remaining sentences 414 of the one or more documents 114 in combination with the supporting sentences 406 combinedly entail the statement 120a. After each of the remaining sentences 414 have been processed, the answer attribution system 112 attributes the statement 120a to the identified supporting sentence(s) 406. Additionally, this process is repeated for each of the statements 120 of the decomposed answer 204. In one or more implementations, therefore, the answer attribution system 112 attributes one or more statements 120 to multiple sentences 116, and attributes one or more statements 120 to just one sentence 116.

Moreover, the sentence selection algorithm 408 greedily evaluates a subset of combinations of the sentences 116. In an example in which the one or more documents 114 include a number, N, of sentences 116, there are 2^{N} possible combinations of sentences 116. Rather than generating attribution scores for all 2^{N} possible combinations of sentences 116, the described techniques solely generate attribution scores 402 between the statement 120a and each individual statement 120a, and then the sentence selection algorithm 408 iteratively evaluates each remaining sentence 116 once for addition to the list of supporting sentences 406. In other words, the described techniques generate (2N−1) attribution scores for each statement 120. As a result, the sentence selection algorithm increases computational speed, and reduces consumption of computational resources with respect to the task of attributing statements 120 to combinations of sentences 116.

It should be noted that one or more machine learning models (e.g., the text decomposition model 202, the natural language inference model 206, the generative text model 302, the image captioning model, the video summarization model, and/or the large language model leveraged for summarizing transcribed audio) are publicly available machine learning models. Thus, in order to access functionality of such machine learning models, the answer attribution system 112 communicates application programming interface (API) calls (e.g., over the network 110) to API endpoints implementing the machine learning models, and receives API responses (e.g., over the network 110) from the API endpoints containing data as processed by the machine learning models in accordance with the API requests.

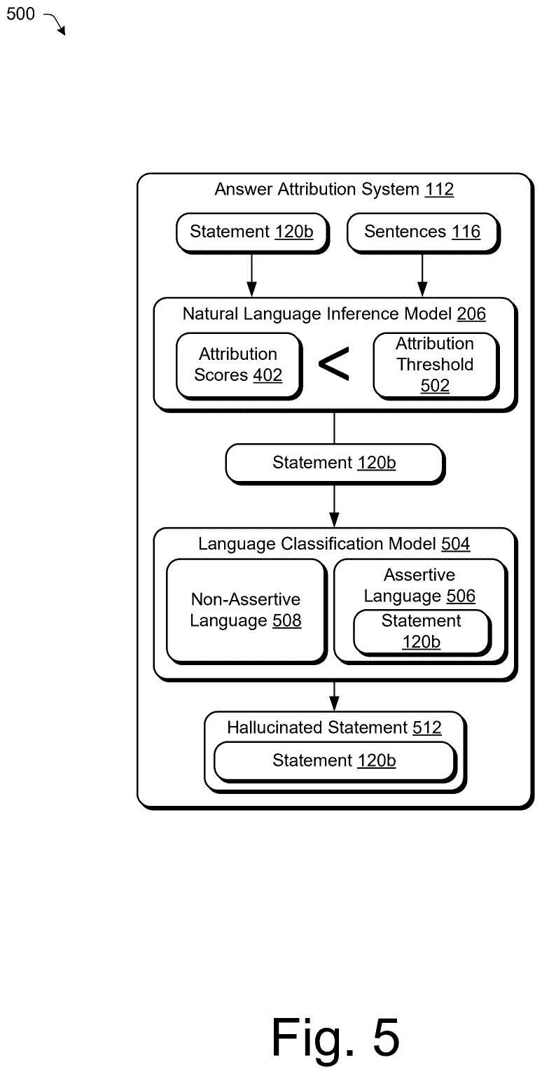

FIG. 5 depicts a system 500 in an example implementation showing operation of an answer attribution system to identify a statement as hallucinated by a generative text model. As part of attributing the statements 120 to the corresponding sentences 116 of the document 114, the natural language inference model 206 receives a statement 120b and the plurality of sentences 116. Further, the natural language inference model 206 generates attribution scores 402 for each individual sentence 116 with respect to the statement 120b. Here, the answer attribution system 112 determines that each of the attribution scores 402 fall below an attribution threshold 502, and as such, the statement 120b is provided to a language classification model 504.

In other words, while attributing a respective statement 120, the answer attribution system 112 first evaluates whether the attribution scores 402 measured between the respective statement 120 and the individual sentences 116 fall below the attribution threshold 502. If at least one attribution score 402 equals or exceeds the attribution threshold 502, then a sentence 116 having a highest attribution score 404 is added to the supporting sentences 406, and the remaining sentences 414 are evaluated for addition to the supporting sentences 406, as further discussed above with reference to FIG. 4. If, however, each of the attribution scores 402 fall below the attribution threshold 502, then the statement 120b is provided to the language classification model 504.

The language classification model 504 is a machine learning model that has been trained to classify a statement 120 as assertive language 506 or non-assertive language 508. Notably, assertive language 506 corresponds to assertions in the form of facts, opinions, and propositions. It follows that non-assertive language 508 corresponds to language that is not assertions of fact, opinion, or proposition. Non-assertive language 508, for instance, includes questions, filler language (e.g., superfluous or redundant language), suggestions, and so on.

Consider an example in which the answer 118 includes the following language: “the car can be any suitable color, and this begs the question “what is the optimal color choice for the car?” In this example, the text decomposition model 202 decomposes this language into the following statements: “the car can be any suitable color” and “what is the optimal color choice for the car?” Here, the language classification model 504 classifies the statement 120 “the car can be any suitable color” as assertive language because the statement 120 is a proposition. Further, the language classification model 504 classifies the statement 120 “what is the optimal color choice for the car” as non-assertive language because the statement 120 is a question.

In one or more implementations, the answer attribution system 112 trains the language classification model 504 using supervised learning. As part of this, the answer attribution system 112 receives a plurality of training pairs each including a training statement and a label including a ground truth classification, e.g., indicating whether the training statement is assertive language 506 or non-assertive language 508. During a training phase, the language classification model 504 is employed to produce a generated classification, e.g., classifying the training statement as assertive language 506 or non-assertive language 508. Furthermore, the answer attribution system 112 trains the language classification model 504 based on a loss between the generated classification and the ground truth classification. This process is repeated iteratively on different training pairs until the loss converges to a minimum, a threshold number of iterations have completed, or a threshold number of epochs have been processed.

As shown, the language classification model 504 classifies the statement 120b as the assertive language 506, and in response, the answer attribution system 112 determines that the statement 120b is a hallucinated statement 512. If, however, the statement 120b were classified as non-assertive language 508, then the statement 120b would be removed from the plurality of statements 120, and not included as part of the annotated documents 124.

In general, hallucinations are a phenomenon that occur when a generative machine learning model generates content that is nonsensical, irrelevant, or inconsistent with the context provided. In the context of the described techniques for attribution of decomposed paragraphs to supporting documents, a hallucinated statement 512 is a portion of the answer 118 generated by the generative text model 302 that is not supported by the one or more documents 114 provided Here, the statement 120b is determined as hallucinated by the generative text model 302 based on (1) the attribution scores 402 measured between the statement 120b and the individual sentences 116 falling below the attribution threshold 502 and (2) the statement 120b being classified as the assertive language 506.

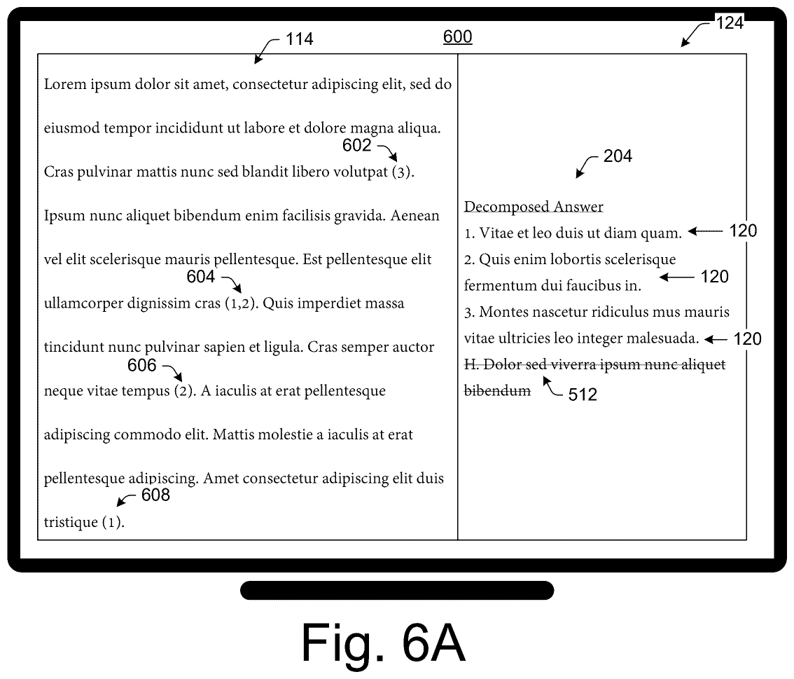

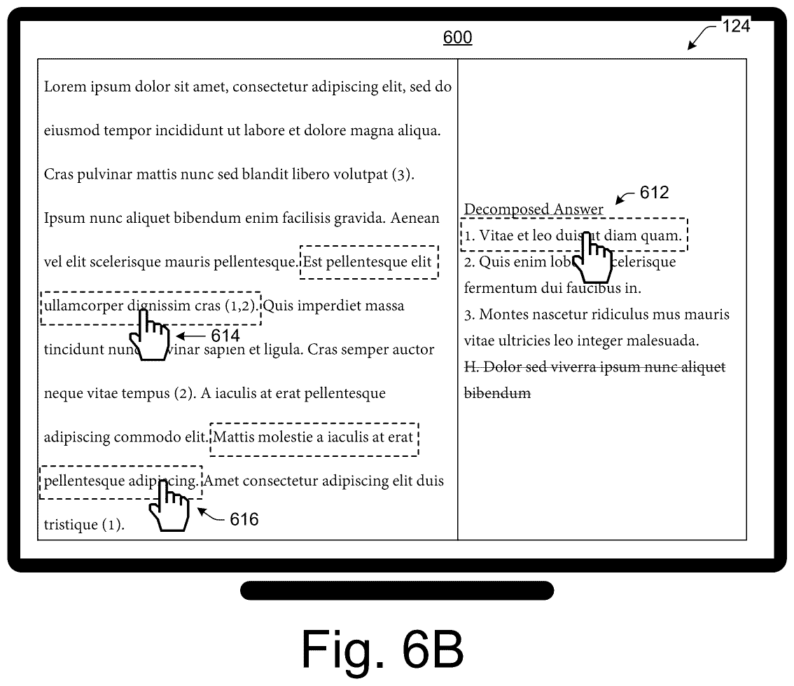

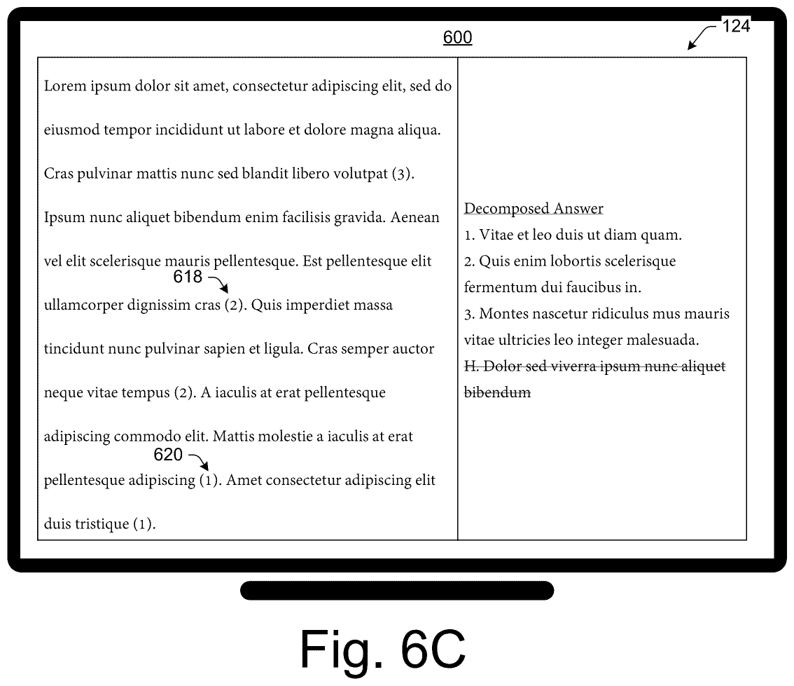

In generating the one or more annotated documents 124, the answer attribution system 112 marks the statement 120b with a visual indicator signifying that the statement 120b is hallucinated by the generative text model 302, as further discussed below with reference to FIG. 6. Additionally or alternatively, the answer attribution system 112 trains the generative text model 302 to reduce hallucinations in generated answers 118 using reinforcement learning.

While attributing the statements 120 to the corresponding sentences 116, for instance, the answer attribution system 112 increases a reward to be provided to the generative text model 302 for each statement 120 that is attributed to at least one sentence 116. In contrast, the answer attribution system 112 decreases the reward to be provided to the generative text model 302 for each statement 120 that is determined to be a hallucinated statement 512. In one or more examples, the answer attribution system 112 decreases the reward to a greater degree in response to identifying a hallucinated statement (e.g., by ten points), in comparison to a degree to which the reward is increased in response to identifying a statement 120 that is attributable to at least one sentence 116, e.g., the reward is increased by one point. For statements 120 that are not attributable to the answer 118 but are classified as non-assertive language 508, the answer attribution system 112 does not change the reward.

After the answer attribution system 112 attributes (or refrains from attributing) each of the statements 120, the answer attribution system 112 updates parameters of the generative text model 302 to maximize the reward. This process is repeated for each answer 118 that the answer attribution system 112 is prompted to decompose and attribute. Over time, the generative text model 302 learns to produce outputs that maximize the reward, and in turn, minimize hallucinated statements 512.

FIGS. 6A, 6B, and 6C depict an example user interface 600 for interacting with an annotated document generated by an answer attribution system. As shown in FIG. 6A, the answer attribution system 112 generates an annotated document 124, and displays the annotated document 124 in the user interface 600, e.g., via the display device 108. The annotated document 124 includes, in a first window of the example user interface 600, the decomposed answer 204 including the plurality of statements 120, as well as a hallucinated statement 512. As shown, the answer attribution system 112 visually distinguishes the hallucinated statement 512 from the attributed statements 120, e.g., the hallucinated statement 512 is struck through and marked with an “H” rather than being numbered.

The annotated document 124 includes, in a second window of the user interface 600, text of the original document 114 as updated to include visual indications 602, 604, 606, 608 of the attributions 122 associating the sentences 116 with corresponding statements 120. For example, the first statement 120 (e.g., statement (1)) is attributed to a fifth sentence 116 of the document 114 (e.g., as shown by visual indication 604) and a tenth sentence of the document 114 (e.g., as shown by visual indication 608), the second statement 120 (e.g., statement (2)) is attributed to the fifth sentence 116 of the document 114 (e.g., as shown by visual indication 604) and a seventh sentence 116 of the document 114 (e.g., as shown by visual indication 606), and the third statement 120 (e.g., statement (3) is attributed to a second sentence of the document 114 (e.g., as shown by the visual indication 602). Notably, sentences 116 of the document 114 are assignable to zero statements 120, one statement 120, or multiple statements 120.

FIG. 6B shows the answer attribution system 112 receiving user feedback to the annotated document 124 updating the attributions 122. As shown in FIG. 6B, the answer attribution system 112 receives a first user input 612 selecting the first statement 120. Further, the answer attribution system 112 receives a second user input 614 selecting the fifth sentence 116 of the document 114 to which the first statement 120 is attributed. This causes the answer attribution system 112 to remove the attribution 122 of the first statement 120 to the fifth sentence 116. In addition, the answer attribution system 112 receives a third user input 616 selecting the ninth sentence 116 of the document 114. Since the first statement 120 is not yet attributed to the ninth sentence 116, the third user input 616 causes the answer attribution system 112 to generate an attribution 122 of the first statement 120 to the ninth sentence 116. In other words, the user feedback (e.g., the user inputs 612, 614, 616) interacting with the annotated document 124 indicates updated attributions of one or more of the statements 120 to different or additional sentences 116 of the document 114.

FIG. 6C shows the user interface 600 as updated to include visual indications of the updated attributions. As shown, the user interface 600 includes a first updated visual indication 618 disassociating the first statement 120 with the fifth sentence 116, e.g., the fifth sentence 116 no longer includes the visual indicator (1) appended to the end of the sentence. Further, the user interface 600 includes a second updated visual indication 620 associating the first statement 120 with the ninth statement, e.g., the ninth sentence 116 now includes the visual indicator (1) appended to the end of the sentence.

In one or more implementations, the answer attribution system 112 is configured to further train the natural language inference model 206 based on a degree of difference between the attributions 122 as generated by the natural language inference model 206 and the updated attributions as specified via user feedback. By way of example, the answer attribution system 112 uses an interactive supervised learning approach, in which the updated attributions are the supervisory signal. In this example, a loss function is employed to generate a loss that captures a difference between the updated attributions and the generated attributions, and the answer attribution system updates the parameters of the natural language inference model 206 to minimize the loss. In this way, the answer attribution system 112 implements a continuous learning approach, in which the natural language inference model 206 continues to learn to attribute the statements 120 to appropriate sentences 116 in the document 114 (after the model 206 has been deployed responsive to an initial training phase on the NLI dataset), and adapts to changing attribution preferences of a user population.

### Example Procedures

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks.

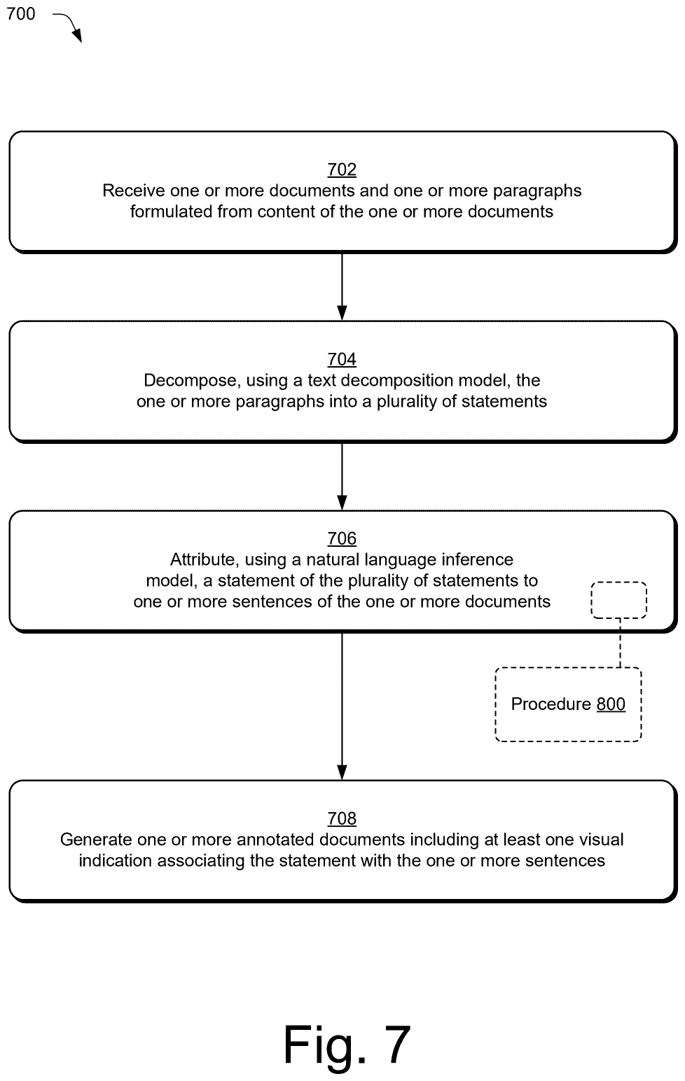

FIG. 7 is a flow diagram depicting a procedure 700 in an example implementation for attribution of decomposed paragraphs to supporting documents. In the procedure 700, one or more documents and one or more paragraphs formulated from content of the one or more documents are received (block 702). By way of example, the answer attribution system 112 receives an answer 118 having one or more paragraphs and one or more documents 114 having a plurality of sentences 116. In one or more implementations, the generative text model 302 generates the answer 118 based on a prompt 304 requesting the generative text model 302 to formulate the answer 118 relying solely on content of the one or more documents 114. Additionally or alternatively, the answer 118 is human-generated.

The one or more paragraphs are decomposed into a plurality of statements using a text decomposition model (block 704). By way of example, the text decomposition model 202 receives the answer 118, and generates a decomposed answer 204 by decomposing one or more paragraphs of the answer 118 into a plurality of statements 120 representing different facts, opinions, or propositions expressed in the answer 118. In one or more implementations, the text decomposition model 202 decomposes at least one sentence of the answer 118 into multiple statements 120.

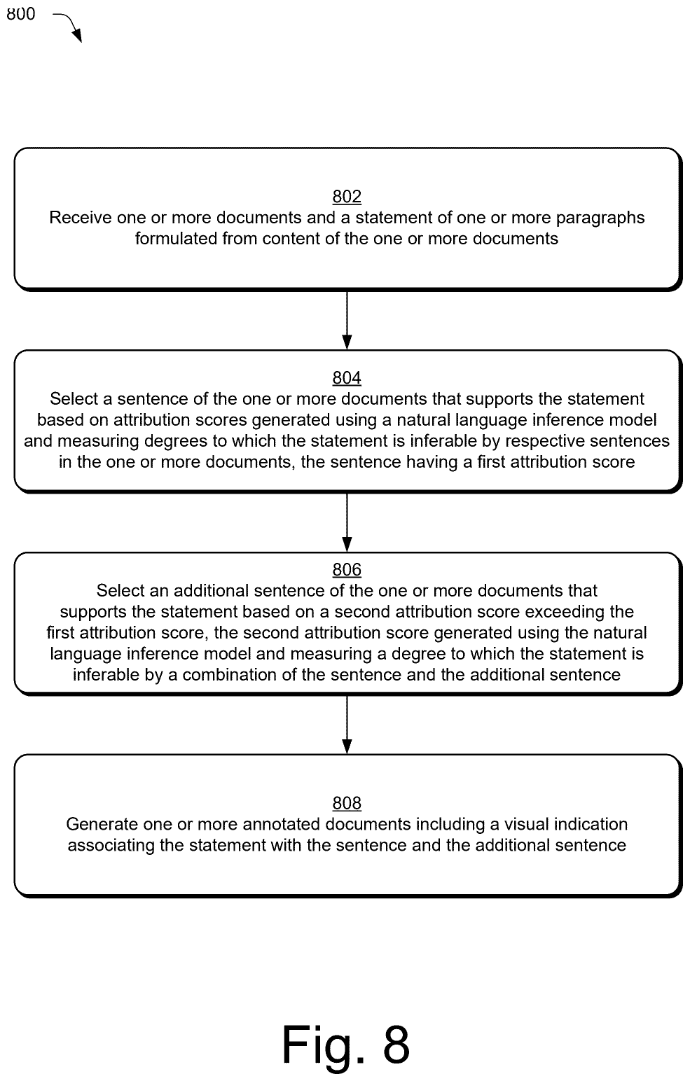

A statement of the plurality of statements is attributed to one or more sentences of the one or more documents using a natural language inference model (block 706). By way of example, the natural language inference model 206 generates attribution scores between a particular statement 120a and different combinations of the sentences 116 of the one or more documents 114. The attribution scores measure a degree to which the particular statement 120a is inferable by the different combinations of the sentences 116. The answer attribution system 112 generates attributions 122 in which the particular statement 120a is attributed to one or more sentences 116 based on the attribution scores. As shown, the block 706 includes a procedure 800 for assigning sentences to the particular statement 120, as further discussed below with reference to FIG. 8.

One or more annotated documents are generated including at least one visual indication associating the statement with the one or more sentences (block 708). By way of example, the answer attribution system 112 generates one or more annotated documents 124 including visual indications of the attributions 122. As part of this, the answer attribution system 112 incorporates the decomposed answer 204 into the one or more annotated documents 124, and marks the statement 120 with visual indicators, e.g., the statements 120 are numbered. Further, the answer attribution system 112 marks the sentence(s) 116 assigned to the particular statement 120a with a visual indicator of the particular statement 120a, e.g., the sentence(s) 116 have the number of the particular statement 120a appended to the end of the sentence(s) 116.

FIG. 8 is a flow diagram depicting a procedure 800 in an example implementation for attribution of decomposed paragraphs to supporting documents. In the procedure 800, one or more documents and a statement of one or more paragraphs formulated from content of the one or more documents are received (block 802). By way of example, the answer attribution system 112 receives a particular statement 120a of the decomposed answer 204, and the sentences 116 of the one or more documents 114 from which the answer 118 was formulated.

A sentence of the one or more documents is selected that supports the statement based on attribution scores generated using a natural language inference model and measuring degrees to which the statement is inferable by respective sentences in the one or more documents, the sentence having a first attribution score (block 804). By way of example, the natural language inference model generates attribution scores 402 for each individual sentence 116 with respect to the particular statement 120a. The attribution scores 402 measure degrees to which the particular statement 120a is inferable by respective individual sentences 116 in the one or more documents 114. Furthermore, the answer attribution system 112 adds a particular sentence 116a having the highest attribution score 402 from among the attribution scores 402 to a list of supporting sentences 406 that support the particular statement 120a.

An additional sentence of the one or more documents is selected that supports the statement based on a second attribution score exceeding the first attribution score, the second attribution score generated using the natural language inference model and measuring a degree to which the statement is inferable by a combination of the sentence and the additional sentence (block 806). By way of example, the natural language inference model 206 generates a combined attribution score 410 measuring a degree to which the particular statement 120a is inferable by a combination of the particular sentence 116a and a first remaining sentence 414 of the one or more documents 114. Further, the sentence selection algorithm 408 compares the combined attribution score 410 to a comparison value 418 which is a summation of the previous attribution score 416 and a delta value 420. Here, the previous attribution score 416 is the highest attribution score 404 associated with the particular statement 120a.

In the procedure 800, the combined attribution score 410 equals or exceeds the comparison value 418, and as such, the first remaining sentence 414 is added to the list of supporting sentences 406 that support the particular statement 120a. Further, the combined attribution score 410 becomes the previous attribution score 416 for a next iteration of the sentence selection algorithm analyzing a next remaining sentence 414 for addition to the supporting sentences 406. If, however, the combined attribution score 410 were to fall below the comparison value 418, the answer attribution system 112 would reject the first remaining sentence 414 as not supporting the statement 120a, e.g., the first remaining sentence 414 is not added to the list of supporting sentences 406. This process is repeated for each remaining sentence 414 of the one or more documents 114, and the particular statement 120a is attributed to the supporting sentences 406 identified after the remaining sentences 414 are processed. In addition, this process is repeated to attribute each of the statements 120 of the decomposed answer 204.

One or more annotated documents are generated including a visual indication associating the statement with the sentence and the additional sentence (block 808). By way of example, the answer attribution system 112 generates one or more annotated documents 124 including visual indications of the attributions 122. As part of this, the answer attribution system 112 incorporates the decomposed answer 204 into the one or more annotated documents 124, and marks the particular statement 120a with a visual indicator, e.g., a particular number. In addition, the answer attribution system 112 marks the particular sentence 116a and the first remaining sentence 414 with the same visual indicator, e.g., the particular number appended to the end of the particular sentence 116a and the first remaining sentence 414.

### Example System and Device

FIG. 9 illustrates an example system generally at 900 that includes an example computing device 902 that is representative of one or more computing systems and/or devices that implement the various techniques described herein. This is illustrated through inclusion of the answer attribution system 112. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” “component,” and “system” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

What is claimed is:

1. A method, comprising:
receiving, by a processing device, one or more documents and one or more paragraphs formulated from content of the one or more documents;
decomposing, by the processing device and using a text decomposition model, the one or more paragraphs into a plurality of statements;
attributing, by the processing device and using a natural language inference model, a statement of the plurality of statements to one or more sentences of the one or more documents; and
generating, by the processing device, one or more annotated documents including at least one visual indication associating the statement with the one or more sentences.

2. The method of claim 1, wherein the receiving includes generating, using a generative text model, an answer to a prompt requesting formulation of the answer relying solely on the content of the one or more documents, the answer including the one or more paragraphs.

3. The method of claim 1, wherein the decomposing includes decomposing at least one sentence of the one or more paragraphs into multiple statements, the plurality of statements representing different facts, opinions, or propositions expressed in the one or more paragraphs.

4. The method of claim 1, wherein the attributing includes attributing the statement to multiple sentences in the one or more documents.

5. The method of claim 1, wherein the attributing the statement to the one or more sentences includes:
generating, using the natural language inference model, attribution scores measuring degrees to which the statement is inferable by respective sentences in the one or more documents; and
attributing the statement to a sentence in the one or more documents based on the attribution scores, the sentence having a first attribution score.

6. The method of claim 5, wherein the attributing the statement to the one or more sentences includes:
generating, using the natural language inference model, a second attribution score measuring a degree to which the statement is inferable by a combination of the sentence and an additional sentence of the one or more documents; and
attributing the statement to the sentence and the additional sentence based on the second attribution score exceeding the first attribution score.

7. The method of claim 1, further comprising:
generating, using the natural language inference model, attribution scores measuring degrees to which an additional statement of the plurality of statements is inferable by respective sentences of the one or more documents; and
classifying, using a language classification model, the additional statement as assertive language or non-assertive language based on the attribution scores falling below a threshold.

8. The method of claim 7, wherein the generating the one or more annotated documents includes marking, based on the additional statement being classified as the assertive language, the additional statement as hallucinated by a generative text model used to generate the one or more paragraphs.

9. The method of claim 7, further comprising determining, based on the additional statement being classified as the assertive language, that the additional statement is hallucinated by a generative text model used to generate the one or more paragraphs, wherein the generative text model is trained using reinforcement learning to reduce hallucinations based on a reduced reward provided to the generative text model in response to the statement being determined as hallucinated by the generative text model.

10. The method of claim 1, the method further comprising receiving user feedback interacting with the one or more annotated documents, the user feedback indicating updated attributions attributing the statement to at least one different or additional sentence in the one or more documents, wherein the natural language inference model is trained based on a degree of difference between attributions as generated by the natural language inference model and the updated attributions.

11. A system comprising:
a processing device; and
a memory storing instructions that are executable by the processing device to perform operations including:
receiving one or more documents and one or more paragraphs formulated from content of the one or more documents; and
presenting one or more annotated documents in a user interface, the one or more annotated documents including a plurality of statements as decomposed from the one or more paragraphs, and at least one visual indication associating a statement of the plurality of statements to one or more corresponding portions of the content of the one or more documents, the statement having been attributed to the one or more corresponding portions of the content using a natural language inference model.

12. The system of claim 11, wherein the receiving includes generating, using a generative text model, an answer to a prompt requesting formulation of the answer relying solely on the content of the one or more documents, the answer including the one or more paragraphs.

13. The system of claim 11, the operations further including decomposing, using a text decomposition model, the one or more paragraphs into the plurality of statements representing different facts, opinions, or propositions expressed in the one or more paragraphs, at least one sentence of the one or more paragraphs being decomposed into multiple statements.

14. The system of claim 11, the operations further comprising attributing the statement to the one or more corresponding portions of the content by:
generating, using the natural language inference model, attribution scores measuring degrees to which the statement is inferable by respective portions of the content of the one or more documents; and
attributing the statement to a portion of the content of the one or more documents based on the attribution scores, the portion of the content having a first attribution score.

15. The system of claim 14, wherein the attributing the statement to the one or more corresponding portions of the content includes:
generating, using the natural language inference model, a second attribution score measuring a degree to which the statement is inferable by a combination of the portion of the content and an additional portion of the content of the one or more documents; and
attributing the statement to the portion of the content and the additional portion of the content based on the second attribution score exceeding the first attribution score by at least a predetermined delta value.

16. The system of claim 11, the operations further comprising:
receiving, via the user interface, user feedback attributing the statement to at least one different or additional portion of the content; and
presenting one or more updated visual indications in the user interface, the one or more updated visual indications associating the statement with the at least one different or additional portion of the content.

17. The system of claim 16, wherein the natural language inference model is trained based on a degree of difference between original attributions of the statement to the one or more corresponding portions of the content as generated using the natural language inference model and updated attributions of the statement to the at least one different or additional portion of the content as indicated by the user feedback.

18. A non-transitory computer-readable medium storing executable instructions, which executed by a processing device, cause the processing device to perform operations comprising:
receiving one or more documents and one or more paragraphs formulated from content of the one or more documents;
decomposing, using a text decomposition model, at least one sentence of the one or more paragraphs into multiple statements;
attributing, using a natural language inference model, a statement of the multiple statements to one or more sentences of the one or more documents; and
generating one or more annotated documents including at least one visual indication associating the statement with the one or more sentences.

19. The non-transitory computer-readable medium of claim 18, wherein the receiving includes generating, using a generative text model, an answer to a prompt requesting formulation of the answer relying solely on the content of the one or more documents, the answer including the one or more paragraphs.

20. The non-transitory computer-readable medium of claim 18, wherein the attributing includes attributing the statement to multiple sentences of the one or more documents.
